(19) United States
(12) Patent Application Publication
(10) Pub. No.: US 2014/0353256 A1
(43) Pub. Date: Dec. 4, 2014

(54) Multi-Barrier System For Water Treatment

(71) Applicant: ITN Nanovation AG, Saarbrücken (DE)

(72) Inventors: Martin Kaschek, Ingbert (DE); Sylvie Verplancke, Saarbrucken (DE); Christof Gränitz, Wahlschied (DE)

(21) Appl. No.: 14/366,563

(22) PCT Filed: Dec. 18, 2012
(86) PCT No.: PCT/EP2012/075879

§ 371 Date: Jun. 18, 2014

(30) Foreign Application Priority Data
Dec. 22, 2011 (EP) 10 2011 056 858.1

(51) Int. Cl. C02F 9/00

(52) U.S. Cl. CPC C02F 9/00; C02F 1/32
USPC 210/663; 210/202

(57) ABSTRACT

A multi-barrier system for cleaning waste water, in particular for the removal of pathogenic microbes from waste water, and a method for the removal of pathogenic microbes from waste water with the multi-barrier system. The multi-barrier system includes an enclosed containment that comprises a first water container, an adjustable ozonation unit, a second water container and a UV unit. In addition, the first water container comprises an ozone-resistant filtration unit.

The present invention relates to a device and a method for cleaning waste water. In particular, the present invention relates to a multi-barrier system and a method for the removal of pathogenic microbes from waste water.

Pathogenic microbes are substances or organisms which cause harmful processes in other organisms and, thus, may cause diseases of these organisms. These may be viruses, bacteria, protozoa, and helminthes. The harmful effect of these pathogenic microbes is mostly based on toxic compounds, in particular enzymes, which are secreted by them, or on an immune reaction caused by them which is triggered in that the pathogenic microbes feed on tissue and blood cells. If untreated, these pathogenic microbes lead to severe diseases or even death in particular of elderly or sick people, but also children.

Pathogenic microbes are frequently found in waste water, in particular in waste water from hospitals, laboratories, swimming pools, and animal processing companies. In order to prevent that pathogenic microbes reach the ground water and, subsequently, into soils, it is often expedient to clean or treat the aforementioned wastewater at their place of origin. The standard method for cleaning waste water is the treatment with aerobic microorganisms. Therein, the wastewater is conducted into a ventilated pool wherein the micro organisms live as flake or film on growth carriers. These microorganisms largely use up waste water ingredients under oxygen consumption and deprive some of the microbes of their livelihood. However, many pathogenic microbes may also survive and proliferate under these conditions as, for example, verotoxin producing Escherichia coli (VTEC) which are also known as enterohemorrhagic Escherichia coli (EHEC). Therefore, waste water containing a high number of pathogenic microbes should be treated with disinfecting methods. For this purpose, known methods of the prior art are available. In particular, these methods include chlorination, thermal disinfection, ozonation, UV disinfection, and filtration.

Chlorination is a chemical method according to which chlorine is added to waste water as a gas (chlorine gas) or hypochlorite solution as it is described, for example, in DE 27 38 484. The dose may be controlled via the residual chlorine content of the waste water. However, costs for required chemicals and dosage technologies are very high. In addition, the hazard potential when dealing with chlorine gas or hypochlorite solution is extremely high. Furthermore, it is known that the chlorination of water leads to the formation of volatile organic chlorine compounds. Most of the known byproducts are toxic trihalomethanes (THM) and chloramines which are suspected to cause allergies. Furthermore, a great number of studies on trihalomethane suggests a correlation between chlorination of drinking and bathing water and a higher risk for cancer of the bladder, colon, rectum, and lung of the human which is why one should refrain from chlorination of waste water for the removal of pathogenic microbes.

The thermal disinfection is a method of disinfection which is based on strong heating of the waste water to be disinfected. This process reduces the number of microbes to a level which makes an infection unlikely. The advantage of thermal disinfection is that it may be carried out easily by means of simple heating such that no further chemicals need to be added and, after cooling down the waste water, no residues remain in the heated waste water. However, this method may not be used where it is necessary to run the process “around the clock” and large amounts of waste water accumulate. In addition, energy costs are very high as the waste water, depending from the microbe, needs to be heated to more than 70° C. for at least 3 minutes. Furthermore, lime which precipitates from 60° C. causes additional problems. Based on the fact that waste water may only be conducted into public waste water plants below a specified maximum temperature, cooling tanks and pools should be provided in this process for cooling down the heated waste water.

During ozonation, as described in DE 37 11 407, both microbes and algae are killed by the high oxidation potential of ozone, wherein the filterability of the finely dispersed impurities is improved. An advantage of the ozonation is the reactivity of ozone leading to a very fast inactivation of pathogenic microbes. Due to the fact that the decomposition products of ozone are merely CO2 and oxygen, no chemical residues remain in the treated waste water. The disadvantages of ozone reside in the fact that ozone must not be released into the air as it otherwise lead to irritations of the respiratory tract upon inhalation. Additionally, ozone must not be allowed to remain in the cleaned waste water due to its significant toxicity. Another disadvantage of the ozonation resides in the fact that particulate components in the waste water, and in particular organic substances, lead to a consumption and degradation of ozone which may cause the concentration of ozone to decrease below a critical level whereby a safe disinfection can no longer be ensured.

UV disinfection is a purely physical process, wherein pathogenic microbes which are subjected to UV-C radiation, are inactivated within seconds. The advantage of UV disinfection is the inactivation of pathogenic microbes within seconds and the absence of environmental pollution as no chemicals need to be added to the waste water. Furthermore, this method is non-corrosive and may be carried out independently from the pH value of the waste water. A disadvantage of the UV disinfection is the fact that good efficiency may only be achieved if turbid materials and colouring agents are largely removed before irradiation as the penetration depth of the UV radiation into waste water is reduced to such extent by dispersion and/or absorption that a reliable disinfection can no longer be ensured.

The filtration of waste water being contaminated with pathogenic microbes is based on a physical (mechanical) membrane separation method, wherein organic or inorganic filter membranes may be used. The membrane separation method underlies the principle of mechanical size exclusion, wherein ingredients of the waste water being larger than the membrane pores are completely retained by the membrane. One advantage of the membrane filtration is the cleaning of the waste water without chemical additives. Furthermore, the membrane may be adapted to the specific needs of the user and the corresponding waste water. In contrast to inorganic filter membranes, organic filter membranes have the disadvantage that they may only be regenerated or cleaned insufficiently so that such filter membranes need to be replaced within relatively short time periods. Additionally, organic membranes only have a limited mechanical stability so that they may be damaged easily at elevated liquid pressures. Polymer membranes are often also chemically instable towards oxidants, such as ozone, and towards detergents. In addition, the use of filter membranes is also associated with the general problem of the deposition of a top layer on the exterior surface of the membrane (the so-called fouling) which thereby increases the filtration resistance. This leads to a drastic reduction of the filtration performance and even to a complete blockage and, hence, to a total outage of the filter membrane.

The aforementioned systems have the common disadvantage that in case of a loss or reduction of the main degradation device (no or insufficient chlorine supply, no or insufficient heating, insufficient or no ozone concentration, insufficient or no UV irradiation, no or reduced filtration performance and lack of chemical stability of the polymer filter membrane against oxidants, such as O₃, and detergents) no sufficient degradation of pathogenic microbes in the contaminated waste water takes place or can no longer be ensured. Moreover, the aforementioned systems usually need to be installed stationary and may not be readily taken for mobile use. Known mobile waste water cleaning devices usually have a relatively high maintenance and, when operated continuously, relatively short service life.

The problem underlying the present invention is the provision of a method and a system for cleaning waste water which may overcome the disadvantages of the prior art as far as possible. In particular, it is one object of the present invention to provide a mobile system for cleaning waste water being contaminated with pathogenic microbes which ensures a very safe and reliable disinfection over longest possible and largely maintenance-free periods of time.

This problem is solved by a multi-barrier system for the removal of pathogenic microbes from waste water comprising a first water container, an adjustable ozonation unit, a second water container and a UV unit, wherein the first water container comprises an ozone-resistant filtration unit containing at least one membrane plate of porous oxidic ceramics, wherein the membrane plate has a coating outside and at least one channel inside for the drainage of the filtrate, wherein the pores of the membrane plate have an average diameter of between 1 μm and 10 μm and the coating comprises at least one separating layer produced by means of a coating slip consisting at least partially of nanoscale and/or microscale oxidic particles, wherein the at least one channel of the membrane plate is connected with the second water container such that the filtrate can be transferred into the second water container, wherein the adjustable ozonation unit is coupled with a sprinkler system, wherein the ozone outlet of the ozonation unit is installed in the first water container and the outlet of the sprinkler system is located above the water level of the first water container, wherein the UV unit is installed such that the filtrate in the second water container is irradiated by the UV unit, and wherein the first water container, the filtration unit, the adjustable ozonation unit, the second water container and the UV unit are placed in a closed containment.

Furthermore, the problem is solved by a method for the removal of pathogenic microbes from waste water by means of the inventive multi-barrier system, wherein the method comprises the following steps:

a) supply of waste water being contaminated with pathogenic microbes into the first water container,
b) filtration of the waste water through the filtration unit with the at least one coated membrane plate, wherein the waste water is treated with ozone in the first water container during filtration and the ozone content in the waste water is controlled by means of the ozonation unit being coupled with a sprinkler unit,
c) transferring the filtrate through the at least one channel of the membrane plate into the second water container,
d) irradiation of the filtrate in the second water container with UV radiation in a wavelength range of from 100 nm to 300 nm and a dose of from 50 J/m² to 2000 J/m². The total concentration of pathogenic microbes in the waste water upon release of the filtrate from the second water container should be preferentially less than 100 KbE/ml, preferably less than 10 KbE/ml, and most preferably less than 1 KbE/ml.

According to the present invention, a specific multi-barrier system for cleaning waste water is used, wherein the focus particularly lies in the removal of pathogenic microbes from said waste water. The inventive multi-barrier system is a closed containment, essentially impermeable to gas, with at least one inlet for the waste water being contaminated with pathogenic microbes and at least one outlet for the cleaned water. Two water containers, an ozonation unit and a UV unit are placed in the containment. Waste water containing pathogenic microbes is supplied through the inlet into the first water container. The first water container comprises an ozone-resistant filtration unit through which the waste water being contaminated with pathogenic microbes is filtered and directly transferred into the second water container. Additionally, the first water container comprises the ozone outlet of the adjustable ozonation unit, such that the waste water in the first water container can be contacted with the desired amount of ozone.

The outlet of the sprinkler system according to the invention is located above the water level of the first water container, such that the airspace above the first water container can be sprinkled with water. The sprinkler unit according to the present invention is coupled with the ozonation unit and can be switched on variably.

The waste water being treated with ozone and filtered in the first water container is transferred through one or more inside channels from the filtration unit into the second water container. The UV unit provided according to the present invention is designed and installed such that the filtrate from the first water container can be irradiated with UV radiation in the second water container.

An essential advantage of the inventive multi-barrier system and the inventive method resides in the interaction of the individual disinfection units integrated in the containment comprising a filtration unit, ozonation unit, and UV unit. According to the present invention, these [units] are combined with each other such that the advantages of the individual methods are maintained but the presented disadvantages are at least partially compensated. Additionally, the inventive multi-barrier system ensures a high level of safety as also in case of an outage of one of the components, a strong or sufficient reduction in the concentration of pathogenic microbes in the waste water is achieved. Additionally, the inventive multi-barrier system is placed in a containment such that it may be taken for mobile use, for example for the disinfection of hospital waste water. Moreover, due to the interaction of the units of the inventive multi-barrier system, a long and essentially maintenance-free operation of the system or waste water cleaning process is simple.

In the following, the individual units or stages of the inventive multi-barrier system or the inventive method for cleaning waste water being contaminated with pathogenic microbes are described.

The first stage in the multi-barrier system is set up by the ozonation unit. By means of a continuous ozonation of the waste water in the first water container, the ozone concentration of the waste water is preferably kept constant in a range between 0.1 mg/1 to 0.3 mg/l.

By means of the ozonation both pathogenic microbes and organic substances which are present in the waste water are oxidized or killed whereby the filterability of these substances is improved. The first water container is designed such that the typical retention time or residence time of the contaminated waste water in this water container is sufficient in order to completely or largely kill the pathogenic microbes in the waste water. Accordingly, the ozonation unit represents the first barrier for the pathogenic microbes in the multi-barrier system. One major advantage of the inventive ozonation unit resides in the fact that it is located in an essentially gas-impermeable containment whereby it is prevented that ozone is released into the surrounding air. Another decisive advantage is the coupling of the ozonation unit provided according to the present invention with a sprinkler system. Thereby, the ozone added to the waste water in the first water container which does not dissolve in the water, but rather rises up into the airzone above the waste water in the first water container, can be dissolved by means of sprinkling and, thereby, can additionally be added to the waste water. Therefore, the sprinkler system not only respresents a further safety mechanism in order to prevent the undesired release of ozone from the containment but also provides the possibility to re-feed unconsumed ozone into the waste water whereby the total consumption of ozone may be reduced. Moreover, the total concentration of ozone in the first water container may be controlled not only by the adjustable ozonation unit but also by the coupled switchable sprinkler unit.

The second barrier of the multi-barrier system is set up by the filtration unit which comprises at least one ceramic membrane plate, wherein the membrane plate is designed such that it has a coating outside and at least one channel inside for the drainage of the filtrate. The ozonized waste water in the first water container is filtered by means of the filtration unit according to the present invention whereby further pathogenic microbes or organic substances which have not been oxidized or deactivated by the ozone treatment are retained.

Due to retaining substances in the waste water to be filtered, a so-called cake, meaning a fouling or a scaling layer, may be formed on the membrane plate which may block or plug the pores of the membrane in the course of time. As a consequence, the membrane filtration flow during filtration of the waste water is significantly reduced. Therefore, a periodical cleaning would be required in order to remove these cakes on the membrane. For this purpose, it is suggested in the prior art, for example, to reverse the permeate stream such that the filtrate is pressed through the filter membrane in opposite direction (backwashing). Additionally, the backwashing is typically carried out with clean water which leads to a reduction of the net flow and to a reduction of the efficiency of the system. However, this procedure typically requires additional equipment and an interuption of the regular waste water cleaning. Therefore, another advantage of the inventive multi-barrier system and the inventive method resides in the combination of the ozonation unit and filtration unit in the first water container. Due to the ozone concentration in the waste water of the first water container, pathogenic microbes and organic substances which form cakes are oxidized and decomposed on the membrane such that no blockage or plugging occurs. The inventive membrane is permeable towards ozone and ozone can pass the membrane and, thereby, reach the second water container. Due to the inventive combination of ozone treatment and filtration, the so-called fouling, which may also occur in the inside channel of the membrane plate, may be prevented. Accordingly, the pathogenic microbes and organic substances adhering to the filtration membrane are attacked by ozone when passing the membrane whereby a self-cleaning of the filtration unit occurs.

The inventive filtration unit is designed such that the waste water is filtered through the inside channel of the membrane by applying vacuum.

The UV unit provided according to the present invention represents the third barrier of the multi-barrier system according to the present invention. By means of the UV disinfection, possible residual pathogenic microbes which have passed the ozonation unit and the filtration unit are inactivated. By means of the filtration unit upstream of the UV unit a high penetration depth of the UV radiation is achieved according to the present invention and undesired dispersion and/or absorption is strongly reduced. Accordingly, the combination of a filtration unit and a UV unit allows for a maximum effect of the UV unit. Another advantage resides in the combination of the ozonation unit and the downstream UV unit. As already set out hereinabove, the ozone passes the membrane and, thereby, reaches the second water container. However, the cleaned waste water which exits the inventive containment must not contain any residual toxic ozone. In the second water container, the advantageous combination of the UV unit and ozone takes effect as the residual ozone in the filtrate is activated by the UV radiation such that an increasing number of oxygen radicals are formed whereby organic molecules being present are oxidized. Accordingly, the effect of ozone is increased many times over. In the absence of organic substances in the filtrate, the UV light causes the formed oxygen radicals to react with themselves to form oxygen (O₂) which is no longer toxic. Consequently, aggressive ozone is degraded due to the UV treatment, wherein possible residual organic substances are oxidized.

The waste water being contaminated with pathogenic microbes accordingly passes at least three barriers in the inventive multi-barrier system (ozonation unit, filtration unit, and UV unit). Therefore, the multi-barrier system described above is suitable to remove pathogenic microbes from waste water completely such that the disinfected waste water can be fed into the sewer system. Since any of the individual barriers is suitable to remove the pathogenic microbes from the waste water, the inventive system provides a high level of safety, for example in case of an outage of one of the components. In case of conventional systems, there is a risk that an outage cannot be detected or that the waste water is not redirected sufficiently fast whereby pathogenic microbes may reach the sewer system. If possible, this has to be prevented. By means of the inventive multi-barrier system, the possibility of contamination of waste water in the sewer system is significantly reduced as even in case of an outage of one barrier unit, there are still two more fully functional barriers available. Due to the combination of the barriers, additional safety results for the user.

Another advantage resides in the low outage probability of the system. In particular, the prevention of bio fouling on the membrane surface of the filtration unit reduces the outage probability of the system, extends the service life during continuous operation, and may provide a higher flow.

In the following, individual components and terms used herein are explained in more detail.

“Waste water” comprises municipal and industrial waste water as well as precipitation and sewer system water showing no or only very low salt contents, and an organic load which is at least partially biologically treatable. This type of waste water is frequently referred to as black water (“Schwarzwasser”) or grey water (“Grauwasser”).

A “multi-barrier system” according to the present invention is a system which contains several successively staggered barriers or cleaning units. The barriers or cleaning units of the multi-barrier system are suitable to remove pathogenic microbes from the waste water.

“Pathogenic microbes” according to the present invention are substances or organisms which cause harmful processes in other organisms and, thus, may cause diseases of these organisms. These pathogenic microbes particularly include viruses, bacteria, protozoa, and helminthes.

A “containment” in the meaning of the present invention is a bin or container which comprises the first water container, the ozonation unit coupled with a sprinkler system, the second water container, and the UV unit. Additionally, the inventive containment has at least one inlet for the contaminated waste water and an outlet for the cleaned waste water.

A “closed containment” or “gas-impermeable containment” in the meaning of the present invention is a containment which is designed such that no release of ozone and contaminated waste water can occur. Accordingly, the containment is presently made by use of materials having low permeability coefficients towards ozone.

The “ozone-resistant” filtration unit is a filtration unit which may be operated without losses in function and efficiency during an ozone treatment. In particular, the materials of the membrane of the filtration unit are not sensitive towards oxidation.

The filtration unit of the present invention comprises at least one membrane plate of porous oxidic ceramics. Furthermore, the filtration unit, in one embodiment, comprises a holder. A holder suitable for the filtration unit is disclosed in DE 10 2006 022 502 or DE 10 2008 036 920.

“Ceramics” in the meaning of the present invention is an inorganic non-metal material being formed at room temperature from a raw mixture and which achieves its typical material properties in a sinter process at high temperatures.

“Oxidic” ceramics in the meaning of the present invention essentially consist of metal oxides. Preferred ceramics are based on oxides of the following metals: Mg, Ca, Sr, Ba, Al, Si, Sn, Sb, Pb, Bi, Ti, Zr, V, Mn, Nb, Ta, Cr, Mo, W, Fe, Co, Ru, Zn, Ce, Y, Sc, Eu, In, and La, or mixtures thereof. Particularly preferred ceramics are based on aluminium oxide and zirconium oxide, and most preferred are ceramics based on aluminium oxide.

“Porous” in the meaning of the present invention indicates that the membrane plate has pores through which the waste water can be filtered. The porous oxidic ceramics of the membrane plate (substrate) preferably have pores with an average diameter of between 1 μm and 10 μm, particularly preferred between 1 μm and 6 μm, in particular between 1 μm and 3 μm. The average pore diameter is determined using mercury porosimetry.

Furthermore, the membrane plate has a coating outside, wherein the coating comprises at least one separating layer produced by means of a coating slip containing nanoscale and/or microscale particles or which is produced from compositions containing nanoscale and/or microscale particles, respectively. Preferably, the at least one separating layer is produced from a composition with a percentage of nanoscale particles in the coating slip of at least 5 wt.-%, particularly preferred at least 25 wt.-%, in particular at least 40 wt.-%, based on the total weight of the slip.

“Nanoparticles” in the meaning of the present invention are particles having an average particle diameter (also referred to as average particle size) of not more than 1000 nm, preferably less than 500 nm, and most preferably less than 100 nm, or re-dispersible agglomerates of such particles. “Microparticles” in the meaning of the present invention are particles with an average particle diameter (also referred to as average particle size) in the range of from at least 1 μm and 50 μm, preferably in the range of from 2 μm and 20 μm, and most preferably in the range of from 5 μm and 10 μm. Unless indicated otherwise, the average particle diameter in the present case is understood to be the particle diameter referring to the volume average (d90 value). The d90 value is determined by means of dynamic light scattering, for example with a UPA (ultrafine particle analyzer). The principle of dynamic light scattering is also known as “photon correlation spectroscopy” (PCS) or “quasi elastic light scattering” (QUELS). In cases of particularly small particles also quantitative methods by electron microscopy (in particular TEM) may be used. Moreover, X-ray diffraction (XRD) may be used to determine the primary particle size. Furthermore, it is possible to determine the primary particle size in suspension by means of laser granulometry, for example with a laser granulometer from CILAS.

A “Coating slip” in the meaning of the present invention is a slip used for the production of a coating which comprises at least one separating layer. A “slip” in the meaning of the present invention is a water-mineral mixture (also mass) for the manufacture of ceramic products.

According to the present invention, the coating on the membrane plate may exclusively consist of the at least one separating layer. However, in a particularly preferred embodiment, the coating comprises at least one further porous layer arranged between the membrane plate and the separating layer. The at least one separating layer preferably is the outside layer, where the separation of the microorganism essentially takes place.

The coating of the membrane plate, comprising at least one separating layer, preferably has a thickness of between 100 nm and 150 μm, preferably between 500 nm and 100 μm, in particular from about 25 μm to 60 μm.

The thickness of the at least one separating layer preferably is in the range of between 100 nm and 75 μm, in particular in the range of between 5 μm and 50 μm, in particular about 25 μm.

The pore size of the pores in the at least one separating layer has an average diameter of between 1 nm and 1400 nm, preferably between 50 nm and 500 nm, in particular between 50 nm and 300 nm, particularly preferred between 200 nm and 300 nm. The pore size of the pores in the at least one separating layer depends on the composition of the coating slip. At relatively low sinter temperatures, nanoparticles act as binders for microparticles in the separating layer. By means of an increase of the percentage of nanoparticles in the coating slip, the pore size or the sinter temperature may be reduced. The pore size of the pores is determined by means of mercury porosimetry in case of average diameters of ≧100 nm, and by means of a bubble point test (also bubble pressure test or blow point measurement) in case of average diameters of below 100 nm.

Depending on the average pore diameter, a micro or ultra filtration or a combination of both methods can be carried out. Where the pore diameter is less than 100 nm, this typically represents an ultra filtration, while it typically represents a micro filtration where the pore diameter is higher than 100 nm. The transitions between these two filtration types are smooth and depend on the pore geometry and the method used.

Sintered membranes have different filtration mechanism compared with polymer membranes. Therefore, numeric cut-offs for polymer membranes cannot be compared directly with those of sintered membranes having a similar average pore diameter.

If necessary, further layers or separating layers may be found underneath the inventive separating layer. It is preferred that layers lying underneath have greater pores compared with the separating layer outside. Particularly preferred, there exists a gradient in pore size from the inside to the outside separating layer. Accordingly, it is preferred that the pore sizes decrease from the inside to the outside. The further porous layers or separating layers which may be arranged between the at least one outside separating layer and the membrane plate have pore sizes lying between the pore size of the outside separating layer (smallest pore sizes) and the pore size of the membrane plate (having the largest pores). This particularly applies to the average pore sizes within the layers (as the pore size within one layer may not be homogenous, overlaps with respect to the absolute pore sizes may occur so that, for example, the size of the largest pores of the at least one separating layer may exceed the size of the smallest pores of the at least one further porous layer).

The nanoparticles or microparticles in the separating layer are preferably oxidic nanoparticles, in particular aluminium oxide particles. In addition, nanoparticles in particular from zirconium dioxide or titanium dioxide or also mixtures of the described oxidic nanoparticles may be preferred. For particularly thin separating layers, in particular zeolites are especially suitable. In further preferred embodiments, the nanoparticles may also be non-oxidic nanoparticles.

Furthermore, the membrane plate has at least one channel inside for the drainage of the filtrate. However, preferred are several channels, preferably arranged in parallel to each other, extending uniformly inside the membrane plate. Preferably, the filtrate is obtained by continuous or discontinuous application of vacuum to the channel side of the filtration unit. Thereby, the waste water is drawn from the first water container through the membrane or filtration unit into the channel(s) and transferred into the second water container. Thereby, the filtrate does no longer get into contact with the waste water being contaminated with pathogenic microbes in the first water container. In a preferred embodiment, any of the inside channels of the membrane plate converge in a collecting channel so that only one collecting channel per filtration unit is connected with the second water container. The more channels are bundled, the larger is each channel diameter.

According to the present invention, no restrictions exist as regards the geometry of the membrane plate. In this respect, round or squared membrane plates may be preferred, depending on each individual case.

Additionally, the size of the membrane plate must be adapted for each application. The principle is: the larger the surface of the membrane plate, the higher the possible throughput of waste water per time unit. The maximum extension of the membrane plate is merely defined by the spatial limitation of the first water container. In a preferred embodiment, the membrane plate does not exceed a length and width of 150 cm. In a particularly preferred embodiment, the membrane plate has a length of about 50 cm and a width of about 11 cm.

The thickness of the membrane plate according to the present invention preferably is in the range between 0.15 mm and 20 mm, in particular between 0.5 mm and 10 mm. In a particularly preferred embodiment, the membrane plate has a thickness of about 6 mm.

Furthermore, the number of membrane plates depends on the individual requirements of the multi-barrier system. In cases where two or more membrane plates are present, these are arranged in a series, and preferably in parallel to each other. In case of relatively low amounts of waste water, the arrangement of from 3 to 15 and preferably 3 to 10 membrane plates per filtration unit is preferred. However, if large amounts of waste water occur, also filtration systems with a correspondingly high number of plates are possible. Preferably, the filtration unit has a modular design which allows for varying the number of membrane plates with regard to the individual requirements.

The first water container comprises at least one filtration unit. However, also several filtration units may be present in the water container. The number of filtration units should be adapted to the waste water amount to be processed.

In a further embodiment, the filtration unit comprises ozone-resistant swinging tongues. These [tongues] are flexibly attached between the individual membrane plates and may move in the waste water flow. By means of this movement, the swinging tongues may wipe across the membrane surface in order to wipe off possible plaques which have formed thereon and settled out. The swinging tongues may consist of, for example, flexible plastic strips, cotton, or synthetic fibres. In a further embodiment, the swinging tongues may be thread-like. The swinging tongues are designed such that they may wipe off plaques on the membrane plates without destroying the membrane plates and their coating.

In a further embodiment, a dosing unit is connected to the first water container. This [dosing unit] may be located inside or outside the containment. By means of the dosing unit, further additives may be dosed into the waste water before, during or after operating the multi-barrier system. Thereby, for example, an additional carbon source, for example in the form of a sugar solution, may be dosed into the waste water in order to supply nutrients to the bacteria being present in the first water container. Furthermore, there is the possibility to add complexing agents to the waste water, for example EDTA, in order to complex ions as, for example, Ca²⁺ for preventing the calcification of the filtration unit and the inside channels. Furthermore, detergents may be supplied into the first water container by means of the dosing unit, which are suitable to clean the filtration unit. Possible detergents are, for example, citric acid or aqueous citric acid solutions or aqueous sodium hypochlorite or hydrogen peroxide solutions. The dosing may be carried out both continuously and semi-continuously.

Furthermore, the inventive multi-barrier system comprises an adjustable ozonation unit which is coupled with a sprinkler unit. In the meaning of the present invention, an “ozonation unit” is a device which is suitable to produce ozone (O₃). The required amount of ozone is produced by the ozonation unit and supplied continuously or discontinuously to the waste water in the first water container or in the inlet. According to the invention, the ozonation unit is adjustable meaning that the amount of produced ozone may be adjusted according to the consumption and depends on the level of contamination of the waste water.

Furthermore, the ozonation unit is coupled with a sprinkler system, wherein the outlet of the sprinkler system is located above the water level of the first water container. Thereby, the ozone which does not dissolve in the water but rather rises up into the airzone above the waste water in the first water container can be dissolved by means of sprinkling and, thereby, can additionally be added to the waste water. Therefore, the sprinkler system not only respresents a further safety mechanism in order to prevent the undesired release of ozone from the containment but rather also provides the possibility to re-feed unconsumed ozone into the waste water whereby the total concentration of consumed ozone may be significantly reduced. According to the present invention, the sprinkler system may contain both one and more sprinkler nozzles. Furthermore, the water which is used for the sprinkler system may be taken from both an external water source and from the first and/or second water container. Another advantage of the sprinkler system resides in the possible cleaning of the filtration unit by means of the sprinkler system. In cases where the cleaning of the filtration unit should be necessary due to excessive fouling or due to a blockage of the filtration unit, the waste water in the first water container may be released and the filtration unit may be rinsed by means of the sprinkler system.

Furthermore, the inventive multi-barrier system comprises a UV unit, which is installed such that the filtrate in the second water container is irradiated by the UV unit. In the meaning of the present invention, a “UV unit” is a radiation source which is suitable to radiate high-energy electromagnetic radiation. The ultraviolet spectrum of the UV unit may comprise wavelengths from 1 nm to 380 nm corresponding to a frequency range of the radiation of from 789 THz (380 nm) to 300 PHz (1 nm). UV radiation may be divided into UV-A, UV-B and UV-C radiation. UV-A radiation is also referred to as near-UV or blacklight and comprises wavelengths of from 380 nm to 315 nm. UV-B radiation is also referred to as medium-UV or Dorno-radition and comprises wavelengths of from 315 nm to 280 nm. UV-C radiation comprises wavelengths of from 280 nm to 100 nm, wherein it is divided into UV-C-FUV (far-UV, 280 nm to 200 nm) and UV-C-VUV (vacuum-UV, 200 nm to 100 nm). From 100 nm to 1 nm, the so-called extreme UV follows. In a preferred embodiment, the UV unit generates the UV-C range, in particular the bactericidal UV-C range which corresponds to the UV-C-FUV range. In a further preferred embodiment, the UV unit provides a wavelength of 253 nm as this corresponds to the absorption maximum of the microorganisms. The UV unit may be, for example, a mercury vapour lamp, a xenon lamp, an amalgam lamp, or a UV-LED lamp.

In a further embodiment, the containment of the multi-barrier system is transportable. “Transportable” in the meaning of the present invention indicates that the containment may be transported and, thus, does not need to be installed at a fixed place. Therefore, the produced multi-barrier system may be advantageously delivered ready for use ex works and does not need to be assembled individually on-site. Additionally, it may be moved easily to another place. For this purpose, machines as, for example, cranes, lifting platforms or heavy goods transporters are required, depending on the size and weight of the containment. The containment may be for example a 20 ft, 40 ft, or a 45 ft container, preferably a standard freight container. In a particularly preferred embodiment, the containment has maximum dimensions of 6.06 m×2.44 m×2.59 m and preferably has a maximum weight of 25,000 kg

Furthermore, the present invention relates to a method for the removal of pathogenic microbes from waste water by means of the multi-barrier system as described hereinabove. The method comprises the following steps:

a) Supply of waste water being contaminated with pathogenic microbes into the first water container. Preferably, the waste water is waste water from a hospital. This [waste water] reaches the first water container via the inlet through a sewage pipe or by means of a water pump.
b) Filtration of the waste water through the filtration unit with the at least one coated membrane plate, wherein the waste water is treated with ozone in the first water container during filtration.
c) Transferring the filtrate through the at least one channel of the membrane plate into the second water container,
d) Irradiation of the filtrate in the second water container with UV radiation in a wavelength range of from 100 nm to 300 nm and a dose of from 50 J/m² to 2000 J/m².

By means of the inventive method, the total concentration of pathogenic microbes being present in the water may be eliminated or is significantly reduced. In one embodiment, the total concentration of pathogenic microbes being present in the water upon release of the filtrate from the second water container is less than 100 KbE/ml, preferably less than 10 KbE/ml, and most preferably less than 1 KbE/ml

In a further embodiment of the inventive method, the pathogenic microbes being present in the waste water are removed from the waste water to an extent of at least 99.90%, preferably at least 99.99%.

The definitions, embodiments and advantages described in connection with the inventive device, i.e. the multi-barrier system, equally apply to the inventive method.

As already set out hereinabove, a so-called cake or plaques are frequently formed on the membrane plate of the filtration unit due to retaining pathogenic microbes or organic substances which may block or plug the pores of the membrane in the course of time. Moreover, so-called fouling may occur in the inside channels of the at least one membrane plate. According to the present invention, these processes are reduced or prevented by means of the ozone treatment. In a preferred embodiment of the inventive process, the ozone penetrates the at least one membrane plate of the ozone-resistant filtration unit during operation. Thereby, the cake on the membrane may be oxidized and degraded so that blockage or plugging does no longer occur. Additionally, the fouling in the inside channel of the membrane plate may be slowed or prevented.

The ozone concentration in the first water container is preferably adjusted such that the amount of ozone provided by the ozonation unit is sufficient in order to oxidize or kill both pathogenic microbes and organic substances being present in the waste water. The required amount of ozone thus depends on the number of pathogenic microbes and other impurities in the waste water. In order to adjust or control the amount of ozone, the ozone concentration is detected in the filtrate in the outlet of the first water container. If the ozone concentration decreases below a set default value, a control system which is connected with the detector and the ozonation unit sets a higher value and/or the sprinkler system is switched on. If the ozone concentration in the filtrate is too high, the ozone production is reduced by means of the control system. In a preferred embodiment of the inventive method, the amount of ozone to be supplied into the first water container is adjusted such that the concentration of ozone in the filtrate in the outlet is between 0.1 mg/1 and 0.3 mg/l.

Another decisive advantage of the inventive method resides in the coupling of the ozonation unit with the sprinkler system. Thereby, the ozone which does not dissolve in the water but rather rises up into the airzone above the waste water in the first water container can be dissolved by means of sprinkling and, thereby, can additionally be added to the waste water. Therefore, the sprinkler system not only respresents a further safety mechanism in order to prevent the undesired release of ozone from the containment but rather also provides the possibility to re-feed unconsumed ozone into the waste water whereby the total concentration of consumed ozone may be significantly reduced. In a particularly preferred embodiment of the inventive method, the ozone concentration is detected in the airspace in the first water container and the sprinkler system is turned on automatically from a value of 0.5 mg/m³, preferably from a value of 0.3 mg/m³, and most preferably from a value of 0.1 mg/m³. In a further embodiment, the water for the sprinkler system can be taken from the first and/or the second water container.

One disadvantage of the UV disinfection resides in the fact that a good effect can only be achieved if a high penetration depth is achieved. Turbid materials and colouring agents reduce the penetration depth of UV radiation into waste water to such extent by dispersion and/or absorption that a reliable disinfection can no longer be ensured. By means of two upstream barriers in the inventive multi-barrier system (in the form of the filtration and ozonation unit), the turbidity of the filtrate may be reduced significantly whereby the penetration depth of the UV radiation in the second water container is significantly increased.

In a further preferred embodiment, the turbidity of the water being present in the second water container is less than 1 NTU (nephelometric turbidity unit), preferably less than 0.5 NTU, and most preferably 0.2 NTU.

Due to the increased penetration depth of the UV rays, a higher number of microbes are killed at equal doses of UV radition. In other words, the dose of UV irradiation may be reduced, compared with a system having no ozonation and filtration unit.

In a preferred embodiment of the inventive process for the removal of pathogenic microbes from waster water, the dose of UV irradiation is reduced by the factor of 2, preferably by the factor of 3, and most preferably by the factor of 4, compared with a system for the removal of pathogenic microbes which comprises no filtration unit.

As already set out above, the combination of the individual methods provides new advantages for the function and stability of the overall process due to synergistic effects. Usually, microbes cause fouling on the membrane plates. These plaques need to be removed mechanically, physically or chemically after a certain period of time. During this time the system cannot be used. The time from one cleaning to another is also referred to as the so-called service life. Due to the synergistic effects of the ozonation and UV unit with the filtration unit, the service life of the multi-barrier system can be extended by the factor of 5, preferably by the factor of 10, and most preferably by the factor of 15, compared with a system for the removal of pathogenic microbes from waste water without ozonation and UV unit.

In a further embodiment, a biological cleaning stage is carried out upstream of the method. Normally, the biological cleaning stage consists of a ventilated pool in which microorganisms, upon air supply, degrade biological impurities being present in the waste water. Thereby, organic substances of the waste water may already be degraded and inorganic substances may be partially oxidized. In a further embodiment, the biological cleaning stage may be a MBR cleaning stage (membrane bioreactor). In a preferred embodiment, the biological cleaning stage is a MBBR cleaning stage. In the foregoing moving bed biofilm reactor process, which is also referred to as floating bed (“Schwebebett”) process, the advantages of both classical enlivement (“Belebung”) and known biofilm processes are combined. Thereby, on the one hand, the whole available pool volume is used like in enlivement and, on the other hand, one may omit conducting a recycled sludge (“Rückschlammführung”) like in most of the biofilm processes. The biofilm carriers move freely in the water and are retained in the pool by means of an outlet screen. If necessary, biomass which is detachted from the carrier is released from the reactor as surplus sludge and deposited in a secondary clarification. Due to the upstream biological cleaning stage, the waste water can be pre-celaned so that suspended solids and similar impurities are largely removed from the waster water before supplying same to the containment. The biological cleaning stage may likewise be conducted in the inventive containment and, therein, is present in the form of a filtration chamber. Accordingly, an external operation as well as an internal operation of the biological cleaning stage intergrated into the containment is possible. The number of chambers may be higher than one. The chambers may be operated aerobic and/or anoxic and, thus, are equipped with an adjustable blower. Die chambers are preferably manufactured as weldable plastic tanks, in particular made from PE.

In a further embodiment, the method has an upstream equalizer tank (storage tank). This [equalizer tank] allows the storage of waste water before supplying same to the multi-barrier system or the first water container. By means of the equalizer tank, waste water may be collected before transferring same into the first water container whereby the composistion of said waster water may be homogenized before the transfer into the first water container. Accordingly, supplying peaks are prevented. The equelaizer tank may be both inside and outside the containment.

The inventive method allows for the removal of pathogenic microbes from waste water. Pathogenic microbes include, amongst others, viruses, bacteria, protozoa, and helminthes.

Thereby, viruses are defined as infectious particles which spread outside cells (extracellular) by transfer but, however, only may proliferate inside a suitable host cell (intracellular) and, as such, do not consist of cells. Possible viruses which are found in waster water and which can be removed by means of the inventive method are, for example, enteroviruses, e.g., polioviruses, coxsackieviruses and echoviruses, reoviridae, e.g., rotaviruses, adenoviruses, astroviruses and caliciviridae as, for example, coronaviruses and hepatitis viruses.

Thereby, bacteria are defined as prokaryotic microorganisms (microorganisms in which the DNA is not contained in a nucleus separated by a double membrane from the cytoplasm but rather is located in the cytoplasm and agglomerated as a nucleid) which typically can reach sizes of up to a few micrometers and which can have different shapes as, for example, spheres, rods, spirills, sphere chains, rod chains etc.

Possible bacteria which are found in waster water and which can be removed by means of the inventive method are, for example, enterobacteria, e.g., Escherichia coli, Shigella, Salmonella, and Yersinia as well as bacteria of the genus Brucella, Francisella, Pseudomonas, Vibrio, e.g., Vibrio cholerae, Campylobacter, Heliobacter, Leptospira, Listeria, Bacillus, Clostridium, Mycobacterium, e.g., Mycobacterium tuberculosis, Mycoplasma, Chlamydia, Staphylococcus, and Legionella.

Thereby, protozoa are defined as eukaryotic microorganisms (microorganisms having a nucleus). Possible protozoa which are found in waster water and which can be removed by means of the inventive method are, for example, Giadria lamblia, Cryptosporidium parvum, Entamoeba histolytica, Entamoeba dispar, and Naegleria fowleri.

Thereby, helminthes are defined as multicellular endoparasite organisms. Possible helminthes which are found in waster water and which can be removed by means of the inventive method are, for example, helminthes of the genus nematodes, e.g., Ascaris lumbricoides, Trichuris trichiura, and Enteribius vermicularis and helminthes of the genus cestodes, e.g., Taenia species.

In particular, the inventive method is suitable to remove bacteria from the waster water. In a particularly preferred embodiment, the bacertia to be removed are selected from the group consisting of Escherichia coli, Salmonella, Shigella, Mycobacterium tuberculosis, and Vibrio cholerae.

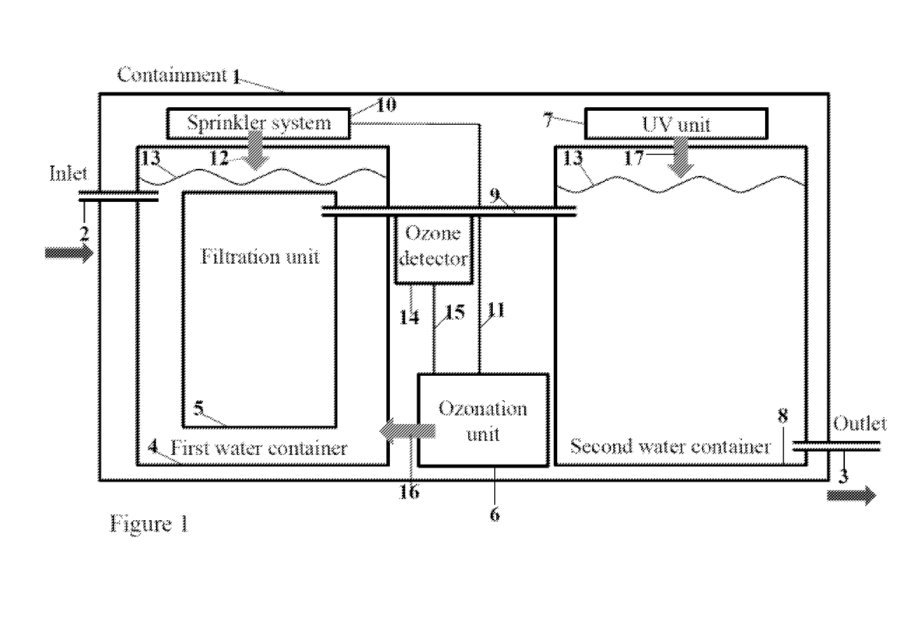

A schematic representation of a possible embodiment of the inventive multi-barrier system is shown in FIG. 1:

The inventive multi-barrier system comprises a closed or gas-impermeable containment (1) with at least one inlet (2) for the waste water being contaminated with pathogenic microbes and at least one outlet (3) for the cleaned water. The containment (1) further comprises a first water container (4) containing the ozone-resistant filtration unit (5), and ozonation unit (6), a UV unit (7) and a second water container (8). The filtration unit (5) is connected with the second water container (8) via at least one outlet (9). In addition, the ozonation unit (6) is coupled (11) with a sprinkler system (10), wherein the outlet (12) of the sprinkler system (10) is located above the water level (13) of the first container (4). An ozone detector (14) is installed such that the ozone concentration can be detected in the filtrate in the outlet (9) of the first water container (4). The detector (14) is connected (15) with the ozonation unit (6). Likewise, the ozone outlet (16) of the ozonation unit (6) is installed in the first water container (4). The UV unit (7) is installed such that the filtrate in the second water container (8) is irradiated (17) by the UV unit (7).

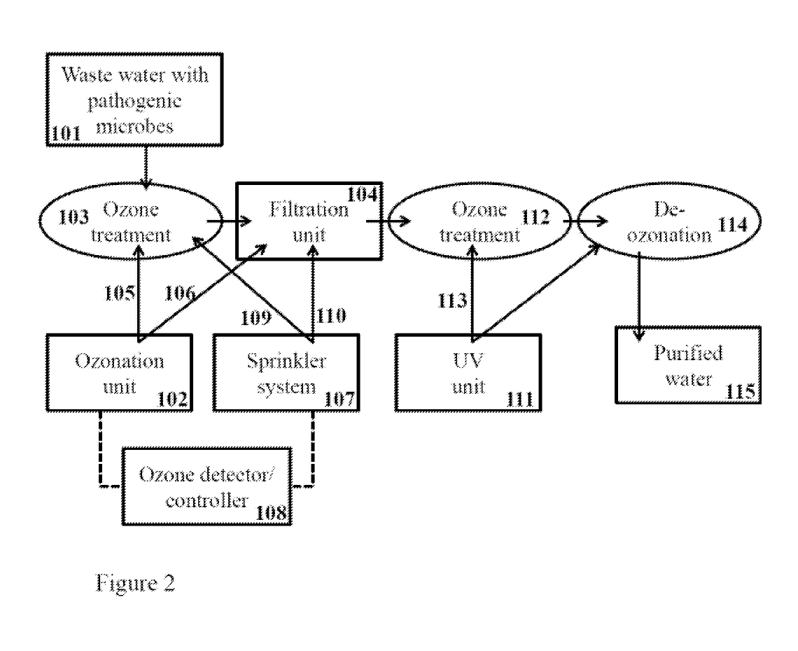

The procedures or the interaction of the individual components of the multi-barrier system in the inventive method are schematically shown in FIG. 2:

The waste water (101) being contaminated with pathogenic microbes are supplied into the first water container. By means of the ozonation unit (102), this waste water is treated (103) with ozone and subsequently filtered through the filtration unit (104). Accordingly, the ozonation of the waste water being contaminated with pathogenic microbes not only takes place during but also after the filtration. Therefore, the ozonation unit (102) not only has an effect (105) on the waste water but also an effect (106) on the filtration unit and, thereby, reduces or prevents plugging of the pores and fouling. The ozonation unit (102) is coupled (108) with a sprinkler system (107) whereby the ozone content in the waste water can be modified (109) by means of the sprinkler system coupled with the ozonation unit. Additionally, the sprinkler system (107) can be used to clean (110) the filtration unit (104). Subsequently, the filtrate is transferred through the at least one channel in the membrane plate into the second water container where it is irradiated (112) with UV radiation by means of the UV unit (111). Thereby, the UV treatment not only provides a disinfection (113) but also provides a de-ozonation (114) of the waste water. Finally, the cleaned waste water (115) may be released from the containment.

Where the term “comprisisng” is used in the description and the claims of the present invention, this does not exclude further embodiments. According to the present invention, the term “consisting of” is a preferred embodiment of the term “comprising”. If in the following disclosure a group is defined to comprise at least a certain number of embodiments, this is also to be understood to disclose a group, which preferably consists only of these embodiments.

In the following, the present invention is explained in more detail on the basis of examples:

### EXAMPLES

A 20 ft freight container which was equipped with three biology chambers (bio tanks) and a filtration chamber with a total volume of about 13 m³ is connected as a peripheral sewage plant to a hospital sewer pipe for the purpose of disinfection and waste water treatment. The hospital produces about 50 m³ waste water per day which is to be cleaned and which is extremely contaminated with pathogenic microbes and faeces.

In addition to the waste water, the three biology chambers were filled to one third with polymeric carriers for biological cleaning and operated in a MBBR modus. The chambers were ventilated periodically by use of high performance blowers such that aerobic and anoxic phases alternate and in order to ensure a biological cleaning of the water, comprising the degradation of nutrients into CO2 as well as nitrification and de-nitrification.

The filtration unit is located in the first water container, downstream from the biological cleaning stage, which, in the present example, comprises two towers with eight stacked filter modules each, wherein a filter module consists of 35 plain membrane plates embedded into a polyurethane holder with an integrated filtrate collecting channel. The filter modules are designed such that they can suck dirty but biologically treated water and draw the cleaned water through the inside channels of the membrane plate when operated in a vacuum mode at 150 mbar vacuum. Particles and suspended solids with a size of greater than 200 nm are retained. The filters are cleaned periodically by backwashing. A chemical cleaning is carried out after larger intervals (up to several months) by means of backwashing the filters with citric acid solution or with sodium hypochlorite solution.

The filters themselves consist of an Al₂O₃ substrate body of 6 mm thickness having a porosity of about 39% and an average pore size of about 5 μm. A micro filtration separating layer of about 50 μm thickeness with pores having an average pore diameter of 200 nm consisting of a mixture of ZrO₂ and Al₂O₃ of different grain sizes is sintered onto the Al₂O₃ substrate. The micro filtration layer itself is produced from a coating slip containing nanocrystalline and microcrystalline particles of ZrO₂ and/or Al₂O₃.

The filtration chamber is equipped with a sprinkler system installed above, which re-introduces ozone produced by an ozone generator which and which may possibly be released into the surrounding air. The ozone generator produces an ozone concentration of constantly 0.2 mg/1 in the first water container, wherein the ozone permeates the membrane and the ozone concentration detectable in the second water container is 0.15 mg/l. After turning off the ozone generator, the ozone concentration in the permeate tank falls below the detection level so that one would expect the growth of microbes after that time, if the filtrate would not be subjected to an additional UV irradiation in the second water container.

For this purpose, the second water container is equipped with a mercury vapour lamp which irradiates the filtrate passing the lamp with a maximum wavelength of 253 nm.

The following measurements were carried out:

Measurement of the total number of microbes in the inlet to the first water container: >1 million microbes/ml.

Measurement of the total number of microbes after filtration: 0-2 microbes/ml. Accordingly, the retention rate is almost 100% whereby only very few microbes reside in the filtrate.

Furthermore, the following specific model microbes were added into the inlet of the first water container at a concentration of >1 million microbes/m1 and the retention rate was measured:

Escherichia coli, Pseudomonas aeruginosa as well as Mycobacterioum terrae. In each of these three cases, the measured retention quote was higher than 99.90%.

Furthermore, the following model microbes were added at a concentration of >1 million microbes/m1 and treated with ozone at a concentration of 0.2 mg/1:

Escherichia coli and Mycobacterioum terrae. After three minutes of ozone treatment, no microbes could be detected. After switching off the ozone generator, no ozone is detectable already after 30 minutes.

The treatment with UV light of the aforementioned microbes leads to a complete inactivation of these pathogenic microbes after 30 minutes.

The invention claimed is:

1. A multi-barrier system for the removal of pathogenic microbes from waste water comprising a first water container, an adjustable ozonation unit, a second water container and a UV unit,
wherein the first water container comprises an ozone-resistant filtration unit that includes at least one membrane plate of porous oxidic ceramics, the membrane plate has pores with an average diameter of between 1 μm and 10 μM, a coating outside and at least one channel inside for the drainage of a filtrate, and the coating comprises at least one separating layer produced with a coating slip comprising nanoscale and/or microscale oxidic particles, wherein the at least one channel of the membrane plate is connected with the second water container so the filtrate can be transferred into the second water container,
wherein the adjustable ozonation unit is coupled with a sprinkler system,
and the ozonation unit includes an ozone outlet positioned in the first water container and an outlet of the sprinkler system is located above the water level of the first water container,
wherein the UV unit is positioned such that the filtrate in the second water container is irradiated by the UV unit, and
wherein the first water container, the ozone-resistant filtration unit, the adjustable ozonation unit, the second water container and the UV unit are placed in a closed containment.

2. Multi-barrier system according to claim 1, wherein the porous oxidic ceramics of the membrane plate have pores with an average diameter in the range of between 1 μm and 6 μm, or between 1 μm and 3 μm.

3. Multi-barrier system according to claim 1, wherein the porous oxidic ceramics are aluminium oxide-based ceramics.

4. Multi-barrier system according to claim 1, wherein the outside coating of the membrane plate has a thickness in the range of between 100 nm and 150 μm, or from 25 μm to 60 μm.

5. Multi-barrier system according to claim 4, wherein the separating layer has pores with an average diameter in the range of between 1 nm and 1400 nm, between 50 nm and 300 nm, or between 200 nm and 300 nm.

6. Multi-barrier system according to claim 5, wherein the oxidic nanoparticles and/or microparticles of the separating layer are preferably selected from the group consisting of aluminium oxide, zirconium oxide, titanium dioxide, and mixtures thereof.

7. Multi-barrier system according to claim 4, wherein the coating of the membrane plate comprises at least one porous layer arranged between the membrane plate and the separating layer.

8. Multi-barrier system according to claim 1, wherein the UV unit comprises a mercury vapour lamp or a UV-LED lamp.

9. Multi-barrier system according to claim 1, wherein the closed containment is transportable.

10. Multi-barrier system according to claim 9, wherein the containment has maximum dimensions of 6.06 m×2.44 m×2.59 m and a maximum weight of 25,000 kg.

11. A method for the removal of pathogenic microbes from waste water by means of a multi-barrier system according to claim 1, the method comprising the steps of
a) providing a supply of waste water contaminated with pathogenic microbes into the first water container,
b) filtering the waste water through the ozone-resistant filtration unit with the at least one coated membrane plate, wherein the waste water is treated with ozone in the first water container during filtration and the ozone content in the waste water is controlled with the ozonation unit being coupled to the sprinkler system,
c) transferring the filtrate through the at least one channel of the membrane plate into the second water container,
d) irradiation of irradiating the filtrate in the second water container with UV radiation in a wavelength range of from 100 nm to 300 nm and a dose of from 50 J/m² to 2000 J/m².

12. Method for the removal of pathogenic microbes from waste water according to claim 11, wherein the total concentration of pathogenic microbes being present in the water upon release of the filtrate from the second water container is less than 100 KbE/ml, less than 10 KbE/ml, or less than 1 KbE/ml.

13. Method for the removal of pathogenic microbes from waste water according to claim 11, wherein the pathogenic microbes being present in the waste water are removed from the waste water to an extent of at least 99.90%, or at least 99.99%.

14. Method for the removal of pathogenic microbes from waste water according to claim 11, wherein the ozone penetrates the at least one coated membrane plate of the ozone-resistant filtration unit during operation.

15. Method for the removal of pathogenic microbes from waste water according to claim 11, wherein the ozone concentration is detected in the filtrate in the outlet of the first water container and the amount of ozone to be supplied to the first water container is adjusted such that the concentration of ozone in the filtrate in the outlet is between 0.1 mg/l and 0.3 mg/l.

16. Method for the removal of pathogenic microbes from waste water according to claim 11, wherein the ozone concentration is detected in the airspace in the first water container and the sprinkler system turns on automatically if the ozone concentration reaches a value selected from 0.5 mg/m 0.3 mg/m³, or 0.1 mg/m³.

17. Method for the removal of pathogenic microbes from waste water according to claim 11, wherein the dose of UV irradiation is reduced by a factor of 2, a factor of 3, or a factor of 4, compared with a system for the removal of pathogenic microbes that does not include a filtration unit.

18. Method for the removal of pathogenic microbes from waste water according to claim 11, wherein the turbidity of the water being present in the second water container is less than 1 NTU, less than 0.5 NTU, or less than 0.2 NTU.

19. Method for the removal of pathogenic microbes from waste water according to claim 11, wherein the service life of the multi-barrier system is extended by a factor of 5, a factor of 10, a factor of 15, compared with a system for the removal of pathogenic microbes from waste water without ozonation and without irradiation with an UV unit.

20. Method for the removal of pathogenic microbes from waste water according to claim 11, wherein a biological cleaning stage is conducted upstream of the multi-barrier system.

21. Method for the removal of pathogenic microbes from waste water according to claim 11, wherein the pathogenic microbes are selected from the group consisting of viruses, bacteria, protozoa, and helminthes, and particularly preferred bacteria.

22. Method for the removal of pathogenic microbes from waste water according to claim 20, wherein the bacteria are selected from the group consisting of Escherichia coli, Salmonella, Shigella, Mycobacterium tuberculosis, and Vibrio cholerae.

23. Multi-barrier system according to claim 2, wherein the outside coating of the membrane plate has a thickness of between 25 μm and 60 μm.

24. Multi-barrier system according to claim 4, wherein the separating layer has pores with an average diameter of between 50 nm and 300 nm.
